(19) United States
(12) Patent Application Publication
(10) Pub. No.: US 2025/0209175 A1
(43) Pub. Date: Jun. 26, 2025

(54) SYSTEMS AND METHODS FOR PERFORMING REMOTE ATTESTATION ON LEGACY TECHNOLOGY

(71) Applicant: DENSO CORPORATION, Kariya (JP)

(72) Inventors: Carlos Mora-Golding, Southfield, MI (US); Ameer Kashani, Southfield, MI (US); Tomonori Ikuse, Kariya-city (JP)

(21) Appl. No.: 18/392,805

(22) Filed: Dec. 21, 2023

(51) Int. Cl. G06F 21/57; G06F 21/44

(52) U.S. Cl. CPC G06F 21/575; G06F 21/44

(57) ABSTRACT

A method for performing remote attestation on legacy technology. The method includes: sending an integrity request to a Root of Trust (ROT); sending an attestation request from the ROT to a device, the attestation request including an encrypted secret; verifying at least one of authenticity, integrity, and freshness of the attestation request with the device; performing a safety test configured to determine whether a predetermined condition is present; initiating a secure boot with the device if the predetermined condition is not present; if the secure boot is successful, the device creates a primary message including the encrypted secret, and sends the message to the ROT; if the secure boot fails, the device creates a secondary message indicating that the secure boot has failed, and sends the message to the ROT.

### TECHNICAL FIELD

The present disclosure relates to systems and methods for performing remote attestation, and more specifically, systems and methods for performing remote attestation on legacy vehicle technology.

### BACKGROUND

Vehicles include software systems for controlling various other systems of the vehicle. The software systems are implemented when the vehicle is designed and built, and many vehicles have limited update capabilities for updating the software systems. Other vehicles may implement over-the-air updates for updating software systems. However, the other systems of the vehicle cannot be updated without updating the hardware on the vehicle. Additionally, updates to either vehicle software or hardware may be made by parties unrelated to the manufacturer of the vehicle, where the modifications may affect the integrity of the vehicle systems. Accordingly, a need exists for a method of checking systems integrity on legacy vehicle systems and components.

### SUMMARY

In a first aspect, a method for performing remote attestation on legacy technology of a vehicle, the method includes: sending an integrity request to a Root of Trust (ROT) of the vehicle; sending an attestation request from the ROT to a vehicle device, the attestation request including an encrypted secret; verifying at least one of authenticity, integrity, and freshness of the attestation request with the vehicle device; performing a safety test configured to determine whether a predetermined condition is present; initiating a secure boot with the vehicle device if the predetermined condition is not present; if the secure boot is successful, the vehicle device creates a primary message including the encrypted secret, and sends the message to the ROT; if the secure boot fails, the vehicle device creates a secondary message indicating that the secure boot has failed, and sends the message to the ROT.

In a second aspect, a computer program product including a non-transitory computer useable medium including a computer readable code, wherein the computer readable code when executed using one or more computing device processors, causes the one or more computing processors to: initiate an integrity request to a Root of Trust (ROT) of a vehicle; send an attestation request from the ROT to a vehicle device, the attestation request including an encrypted secret; verify the of authenticity, integrity, and freshness of the attestation request with the vehicle device; perform a safety test configured to determine whether a predetermined condition is present; initiate a secure boot with the vehicle device if the predetermined condition is not present; if the secure boot is successful, the vehicle device creates a primary message including the encrypted secret, and sends the message to the ROT; if the secure boot fails, the vehicle device creates a secondary message indicating that the secure boot has failed, and sends the message to the ROT.

In a third aspect, a system includes: one or more computing system processors; and memory storing instructions that, when executed by the one or more computing system processors, causes the system to: send an integrity request to a Root of Trust (ROT) of a vehicle; send an attestation request from the ROT to a vehicle device, the attestation request including an encrypted secret; verify at least one of authenticity, integrity, and freshness of the attestation request with the vehicle device; perform a safety test configured to determine whether a predetermined condition is present; initiate a secure boot with the vehicle device if the predetermined condition is not present; if the secure boot is successful, the vehicle device creates a primary message including the encrypted secret, and sends the message to the ROT; if the secure boot fails, the vehicle device creates a secondary message indicating that the secure boot has failed, and sends the message to the ROT.

### BRIEF DESCRIPTION OF THE DRAWINGS

FIG. 1 depicts a flowchart of a method for performing remote attestation on legacy technology of a vehicle, according to one or more embodiments described herein; and

FIG. 2 schematically depicts a system for performing remote attestation on legacy technology of a vehicle, according to one or more embodiments described herein.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. In addition, as referred to in this document “at least one of A, B, C” includes (A), (B), (C) (A & B), (A&C), (B&C), (A & B &C).

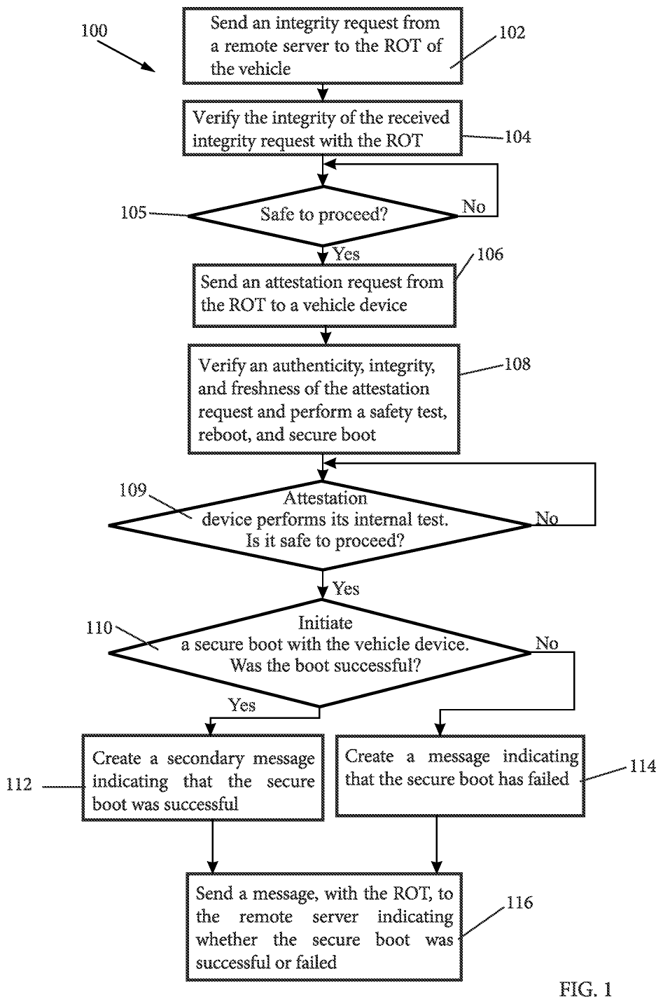

Referring initially to FIG. 1, a method for performing remote attestation on a software system. In embodiments, the method may perform remote attestation on resource-constrained technology of a vehicle, where “resource-constrained technology” refers to technology on a vehicle that is fixed and cannot be updated (such as hardware, one-time programmable code, etc.), or has limited update capabilities. This may include legacy technology and technology being developed that has a lack of hardware and/or software that allows for updating. Update capabilities may be limited by the performance capabilities of computer systems of the vehicle, including memory and processors of the vehicle. As used herein, “vehicle” may refer to motor vehicles, recreational vehicles, boats, aircraft, or the like. However, it is contemplated and possible that the method may perform remote attestation on systems other than vehicles.

Remote attestation may be performed on a software system, such as vehicle software. Remote attestation is performed to test the integrity of the software system, determining any issues that may exist. The issues may occur from bugs in the software, or from modifications to the software and/or hardware related to the software system. In embodiments that include vehicles, this may relate to tuning of the vehicle software, performance modifications, or any other modification, such as manipulation of the mileage of the vehicle. The method determines the integrity of the software system using a root of trust (ROT) of the vehicle, which then sends an attestation request with an encrypted message to a vehicle device, thereby confirming the integrity of the vehicle device.

At step 102, the method may include sending an integrity request from at least one of a remote server to the ROT of the vehicle, an event detector in the vehicle configured to monitor and report a system event (such as a cyber incident), or as a scheduled task in the ROT. In embodiments where the integrity request is a scheduled task in the ROT, the ROT may store a time and date or include a timer that triggers the integrity request to be performed. In embodiments where the integrity request is based on an event detector, a pre-configured vehicle condition, memory value, function callback or system state may trigger the integrity request to be performed. The integrity request may be sent in the form of a signal in a variety of ways, including over a wired connection, a wireless connection, or a combination thereof. At step 104, the method may include verifying the integrity of the received integrity request with the ROT. The ROT may analyze the integrity request to determine whether the integrity request includes a predetermined message, code, signature, or other indication so that the ROT may determine that the integrity request is authentic. The method may further include step 105 verifying an attestation test is safe to proceed based on the verified integrity request. The verification of the integrity request may trigger a safety test that verifies that the attestation test may be performed with or without the existence of predetermined conditions. The safety test is performed by the ROT based on the information it may obtain from the vehicle and other devices. Further, the safety test can be performed by the attestation devices based on internal knowledge as described in step 109. The safety test can be a combination of the ROT and the attestation devices. The predetermined conditions may be related to critical functions, states, or alternative invariants of the device that are known to have freedom from interference or on the other hand, are known to affect the safety of the user(s) of the device. In embodiments where the device is a vehicle device, the attestation test may disable or cause interference with certain functions of the vehicle device that would affect the performance (e.g. drivability) of the vehicle. In such embodiments, the predetermined conditions may be at least one of: the vehicle is in drive, the vehicle is not in park, the vehicle is in motion, a reference monitor indicates a critical task is actively executing on a vehicle device, a threshold for free computation resources exceeds that which is necessary to perform the attestation test, one or more missed task deadlines or similar events that are reported by a system scheduler, an existing attestation request is pending, or an active operation of the vehicle would be disabled by the attestation test. For example, if the vehicle is moving, the safety test may verify that the vehicle device to be rebooted is not one of the predetermined vehicle device(s) that affects the drivability of the vehicle. These predetermined vehicle devices may include steering systems, braking systems, active suspension systems, powertrain systems, user interface systems including the speedometer, or the like. For further example, the method may be implemented in aerial vehicles where the vehicle systems may affect the ability of the aerial vehicle to remain aloft, where the predetermined vehicle devices may be related to flying the aerial vehicle. In yet another example, the method may be implemented in devices other than vehicles, such as medical devices or, more specifically, insulin pumps, where the predetermined conditions may include critical actions of the insulin pump that assists a user with insulin regulation. These predetermined conditions may include an action of pumping insulin or detecting a blood sugar level of the user.

At step 106, the method may include sending an attestation request from the ROT to a vehicle device, where the attestation request includes a primary message with an encrypted secret. The vehicle device may be a vehicle control unit (VCU) communicatively coupled to other vehicle devices, such as an infotainment system, to control operation of those other vehicle devices. The reception of the attestation request may trigger the VCU to perform one or more functions after verifying the authenticity of the attestation request. For example, at step 108, the method may include verifying at least one of authenticity, integrity, and freshness of the attestation request with the vehicle device and performing a safety test, reboot, and secure boot with the vehicle device. In embodiments, the method may verify any combination of or all of the authenticity, integrity, and freshness of the attestation request. The attestation request may determine whether the operation of the vehicle device has been tampered with. This may be accomplished by determining that the coding, or instructions, stored by the vehicle device has not been altered from an original coding stored by the vehicle device during manufacture. At step 109, the method may cause the attestation device to perform an internal test to determine its safe to proceed. At step 110, the method starts with a rebooting process that can be self-initiated or remotely-initiated as performed in “UDS 0x11 service “ECU Reset or alternatively, any remote procedure call (RPC) with equivalent effect”. The method may include initiating a secure boot with the vehicle device and determining whether the secure boot is successful or unsuccessful. If the secure boot is successful, then the method proceeds to step 112, where the vehicle device creates a secondary message indicating that the secure boot was successful. For example, the secondary message may include the encrypted secret and a secure boot hash, where step 112 further includes sending the message to the ROT. If the secure boot fails, then the method proceeds to step 114, where the vehicle device creates a message indicating that the secure boot has failed, and sends the message to the ROT. The secure boot may be unsuccessful, or fail, if the coding or instructions in the vehicle device have been altered or tampered with. Once it is determined whether the secure boot was successful or unsuccessful, at step 116, the method may include sending a message, with the ROT, to the remote server indicating whether the secure boot was successful or failed. The remote server may display the message to a user, or may automatically perform a function in response to the message indicating that the secure boot was successful or failed. In some embodiments, if the ROT determines that the system has been compromised, the ROT may not send a message to the remote server. In such embodiments, the ROT may store a predetermined time threshold that is measured from the start of the method, representing delays in handling requests, such that when the predetermined time threshold is passed without the secure boot being successful, the ROT may continuously log the currently elapsed time and/or determine that the vehicle device is compromised. Furthermore, the ROT may make an indication of such a determination communicably available to other vehicle devices The threshold value is an independent value calculated for each of the attestation devices. The value can be calculated based on the device hardware and program execution. As an example, device A with restrained resources may complete secure boot in 300 ms, while device B, a rich system, may complete a secure boot in under 20 ms. The threshold for each of these devices is different since a risk analysis may determine that after 700 ms device A is compromised while after 70 ms device B is compromised.

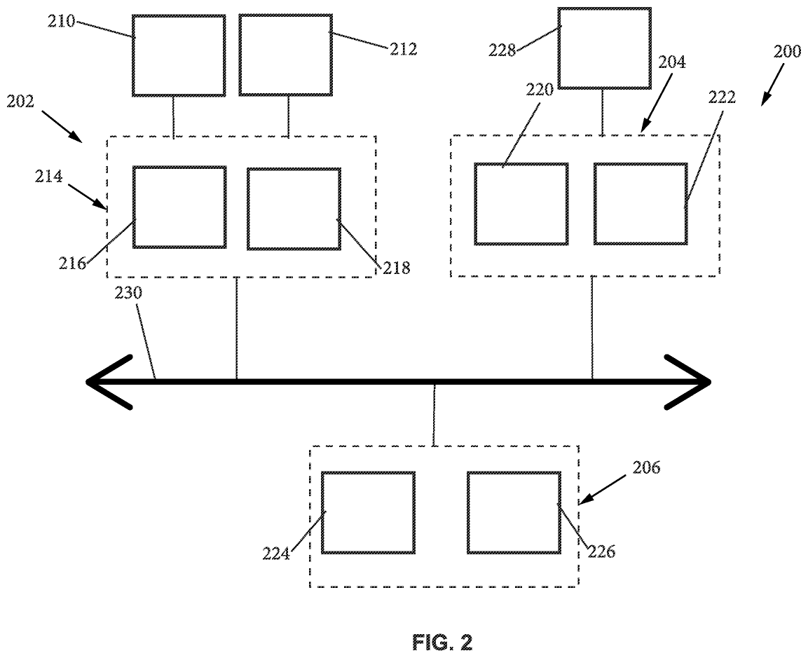

Referring now to FIG. 2, a system 200 for performing remote attestation is depicted. The system 200 may include various structures, as will be described below, to be configured to perform the steps 102-116 of method 100 recited above. As shown in FIG. 2, the system 200 may include a remote entity 202, a main vehicle control unit (MVCU 204) that acts as the Root of Trust, and a plurality of vehicle control units 206 (VCU) that individually control one or more vehicle devices. However, it is contemplated and possible that the MVCU acts as a hypervisor overseeing a plurality of devices, or may be a program separate from the attestation system. The plurality of vehicle control units 206 may be included in the vehicle devices. In some embodiments, the ROT may consider a secure boot to be critical due to a time-lapse for the safety precondition to be not present or as requested by the remote server. In this case, the ROT may choose to alert the user (driver) to perform a task or may disable vehicle functions such that the safety precondition is removed and the secure boot process can be initiated.

The remote entity 202 may include a display 210, an input 212, and a controller 214 with at least one processor 216 and at least one memory 218. The input devices 212 may include a keyboard, a mouse, or any other device capable of a user inputting data to the controller 214. The input devices 212 may be configured for inputting and sending information to the controller 214. As such, the controller 214 may include an input/output (I/O) interface configured to provide digital and/or analog inputs and outputs. The I/O interface can be used to transfer information between internal storage, such as the memory 218, and external input and/or output devices (e.g., display). The I/O interface can include associated circuitry or BUS networks to transfer such information. Such a BUS or associated circuitry can allow the components to be communicatively coupled. The display 210 may be any traditional display for displaying visual information to a user, such as, for example, a screen (e.g., LED, LCD, QLED, etc.). However, it is contemplated and possible that the display 210 may be include non-visual displays of information such as a speaker, brain computer interface (BCI), a tactile feedback device, or the like.

The MVCU 204 may be communicatively coupled to both the remote entity 202 and the plurality of vehicle control units 206 for sending and receiving signals with the remote entity 202 and the vehicle control units 206 and acting as a gateway between the remote entity 202 and the vehicle control units 206. The MVCU 204 may include at least one processor 220 and at least one memory 222 for storing instructions and other data, and performing functions in response to executing the instructions or receiving signals from either of the remote entity 202 or the vehicle control units 206. Each of the vehicle control units 206 may include at least one processor 224 and at least one memory 226 each communicatively coupled with at least one vehicle device 228 for storing and executing instructions for controlling operation of the vehicle device 228. In such manner, the vehicle device 228 is communicatively coupled to the vehicle control units 206.

As used herein, the term “communicatively coupled” means that coupled components are capable of exchanging data signals with one another such as, for example, electrical signals via conductive medium, electromagnetic signals via free space, optical signals via optical waveguides, and the like. Each of the remote entity 202, the MVCU 204, and the vehicle control units 206 may be communicatively coupled along a communication path 230, or separately connected thereto, such as by a controller area network (CAN), internet-oriented protocol (e.g. HTTPS, QUIC, COAP, MQTT, DDS, SOME/IP, DoIP, etc.), universal serial bus (USB), wireless communication (e.g., WiFi, 3G, 4G, 5G, Bluetooth, UWB, etc.) or the like. Each of the processors 216, 220, 224 and non-transitory electronic memories 218, 222, 226 of the remote entity 202, the MVCU 204, and the control units 206 may be communicatively coupled to various components of the system. In some embodiments, the processors and the non-transitory electronic memories and/or the other components are included within a single device. In other embodiments, the processors and the non-transitory electronic memories and/or the other components may be distributed among multiple devices that are communicatively coupled. Each non-transitory electronic memory 218, 222, 226 may store a set of machine-readable instructions. The processors may execute the machine-readable instructions stored in the non-transitory electronic memories. The machine-readable instructions may include software that controls operation of the processors to perform the operations described in the method. The non-transitory electronic memories may include volatile memory and non-volatile memory for storing instructions and data. The non-volatile memories may include solid-state memories, such as NAND flash memory, magnetic and optical storage media, or any other suitable data storage device that retains data when the processor is deactivated or loses electrical power. Non-volatile storage may store compiled and/or interpreted from computer programs created using a variety of programming languages and/or technologies, including, without limitation, and either alone or in combination, Rust, Golang, Ada, Java, Kotlin, C, C++, C#, Objective C, Fortran, Pascal, Java Script, Type Script, Python, Perl, Bash, Tcl, and PL/SQL. The volatile memory may include static and/or dynamic random-access memory (RAM), flash memory, cache memory, or other memory capable of storing program instructions and data. In short, the non-transitory electronic memories may include RAM, ROM, flash memories, hard drives, or any device capable of storing machine-readable instructions such that the machine-readable instructions can be accessed by the processors to output a control signal for the remote entity 202, the MVCU 204, and the vehicle control units 206 to act on. The non-transitory electronic memories may each be implemented as one memory module or a plurality of memory modules.

The processors 216, 220, 224 may be any device capable of executing machine-readable instructions. For example, the processors may be or include an integrated circuit, a microchip, a computer, a microprocessor, a micro-controller, a digital signal processor, a microcomputer, a central processing unit, field programmable gate arrays, programmable logic devices, state machines, logic circuits, analog circuits, digital circuits, or any other devices that manipulate signals (analog or digital) based on computer-executable instructions residing in memory. The non-transitory electronic memories and the processors are coupled to the communication path that provides signal interconnectivity between various components and/or modules of the system 200. Accordingly, the communication path 230 may communicatively couple any number of processors with one another, and allow the modules coupled to the communication path to operate in a distributed computing environment.

The system is configured to perform the steps 102-116 of the method 100 described above. The one or more processors may execute a computer readable code from a computer program product including a non-transitory computer useable medium, or may execute instructions stored by the one or more memories to perform the steps of the method 100. Specifically, the processors of the system 200 may execute the instructions or computer readable code to:
send an integrity request from the remote server to the MVCU 204;
verify the integrity of the received integrity request with the MVCU 204, including analyzing the integrity request with the processor of the MVCU 204 to determine whether the integrity request includes a predetermined message, code, signature, or other indication so that the MVCU 204 may determine that the integrity request is authentic;
verify an attestation test is safe to proceed based on the verified integrity request and the existence of predetermined conditions;
send an attestation request from the MVCU 204 to one of the vehicle control units 206, where the attestation request includes a primary message with an encrypted secret, and the reception of the attestation request may trigger the vehicle control units 206 to perform one or more functions with the vehicle devices after verifying the authenticity of the attestation request;
verifying at least one of authenticity, integrity, and freshness of the attestation request with at least one of the vehicle control units 206;
perform a safety test, reboot, and secure boot with at least one of the vehicle control units 206, wherein the safety test may determine whether at least one of a plurality of predetermined conditions is present;
wherein the attestation request may determine whether the operation of the vehicle control units 206 or the vehicle devices has been tampered with by determining that the coding, or instructions, stored by the vehicle control units 206 or the vehicle devices has not been altered from an original coding stored by the vehicle control units 206 or the vehicle devices during manufacture if the secure boot is unsuccessful;
initiate a secure boot with the vehicle control units 206 or the vehicle devices and determine whether the secure boot is successful or unsuccessful;
if the secure boot is successful, then the vehicle control units 206 or the vehicle devices create a secondary message indicating that the secure boot was successful, the secondary message including the encrypted secret and a secure boot hash, and sending the message to the MVCU 204;
if the secure boot fails, then the vehicle control units 206 or the vehicle devices are configured to create a message indicating that the secure boot has failed and send the message to the MVCU 204, or do not create and send a message, where the secure boot may be unsuccessful, or fail, if the attestation test determines that the coding or instructions in the vehicle control units 206 or the vehicle devices have been altered or tampered with;
display the message to a user via the display 210 of the remote server, and/or automatically performing a function with the at least one processor of the remote server in response to the message indicating that the secure boot was successful or failed.

Once the MVCU 204, has completed the attestation process, it proceeds to draft a report for the remote server including the original sever nonce (or fresh value), and the result of the attestation report (pass/fail). In some embodiments, the report may include data from the device under attestation to increase the credibility of the attestation request.

The present disclosure is further defined by the following clauses:
Clause 1. A method including: sending an integrity request to a Root of Trust (ROT) of the vehicle; sending an attestation request from the ROT to a vehicle device, the attestation request comprising an encrypted secret; verifying at least one of authenticity, integrity, and freshness of the attestation request with the vehicle device; initiating a secure boot with the vehicle device; if the secure boot is successful, the vehicle device creates a primary message comprising the encrypted secret, and sends the message to the ROT; if the secure boot fails, the vehicle device creates a secondary message indicating that the secure boot has failed, and sends the message to the ROT.
Clause 2. The method of clause 1, further comprising performing a safety test and a reboot with the vehicle device.
Clause 3. The method of either of the preceding clauses, wherein the primary message further comprises an indication that the secure boot was successful.
Clause 4. The method of any of the preceding clauses, wherein, if the secure boot fails, the vehicle device creates a message indicating that the secure boot has failed, and sends the message to the ROT.
Clause 5. The method of any of the preceding clauses, wherein the integrity request is sent from a remote server to the ROT.
Clause 6. The method of clause 5, further including sending a message, with the ROT, to the remote server indicating whether the secure boot was successful or failed.
Clause 7. The method of any of the preceding clauses, further including verifying the integrity of the received integrity request with the ROT; and verifying the test is safe to proceed based on the verified integrity request.
Clause 8. A computer program product including a non-transitory computer useable medium including a computer readable code, wherein the computer readable code when executed using one or more computing device processors, causes the one or more computing processors to: send an integrity request to a Root of Trust (ROT) of the vehicle; send an attestation request from the ROT to a vehicle device, the attestation request comprising an encrypted secret; verify at least one of authenticity, integrity, and freshness of the attestation request with the vehicle device; initiate a secure boot with the vehicle device; if the secure boot is successful, the vehicle device creates a primary message comprising the encrypted secret, and sends the message to the ROT; if the secure boot fails, the vehicle device creates a secondary message indicating that the secure boot has failed, and sends the message to the ROT.
Clause 9. The computer program product of clause 8, wherein the computer readable code when executed using one or more computing device processors, causes the one or more computing processors to: perform a safety test and a reboot with the vehicle device.
Clause 10. The computer program product of clauses 8 or 9, wherein the primary message further comprises an indication that the secure boot was successful.
Clause 11. The computer program product of any of the preceding clauses, wherein, if the secure boot fails, the vehicle device creates a message indicating that the secure boot has failed, and sends the message to the ROT.
Clause 12. The computer program product of any of the preceding clauses, wherein the integrity request is sent from a remote server to the ROT.
Clause 13. The computer program product of any of the preceding clauses, wherein the computer readable code when executed using one or more computing device processors, causes the one or more computing processors to: send a message, with the ROT, to the remote server indicating whether the secure boot was successful or failed.
Clause 14. The computer program product of any of the preceding clauses, wherein the computer readable code when executed using one or more computing device processors, causes the one or more computing processors to: verify the integrity of the received integrity request with the ROT; and verify the test is safe to proceed based on the verified integrity request.
Clause 15. A system including: one or more computing system processors; and memory storing instructions that, when executed by the one or more computing system processors, causes the system to: send an integrity request to a Root of Trust (ROT) of the vehicle; send an attestation request from the ROT to a vehicle device, the attestation request comprising an encrypted secret; verify at least one of authenticity, integrity, and freshness of the attestation request with the vehicle device; initiate a secure boot with the vehicle device; if the secure boot is successful, the vehicle device creates a primary message comprising the encrypted secret, and sends the message to the ROT; if the secure boot fails, the vehicle device creates a secondary message indicating that the secure boot has failed, and sends the message to the ROT.
Clause 16. The system of clause 15, wherein the computer readable code when executed using one or more computing device processors, causes the one or more computing processors to: perform a safety test and a reboot with the vehicle device.
Clause 17. The system of clauses 15 or 16, wherein the primary message further comprises an indication that the secure boot was successful.
Clause 18. The system of any of the preceding clauses, wherein, if the secure boot fails, the vehicle device creates a message indicating that the secure boot has failed, and sends the message to the ROT.
Clause 19. The system of any of the preceding clauses, wherein the integrity request is sent from a remote server to the ROT, and the computer readable code when executed using one or more computing device processors, causes the one or more computing processors to: send a message, with the ROT, to the remote server indicating whether the secure boot was successful or failed.
Clause 20. The system of any of the preceding clauses, the computer readable code when executed using one or more computing device processors, causes the one or more computing processors to: verify the integrity of the received integrity request with the ROT; and verify the test is safe to proceed based on the verified integrity request.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for performing remote attestation on legacy technology input, the method comprising:
sending an integrity request to a Root of Trust (ROT);
sending an attestation request from the ROT to a device, the attestation request comprising an encrypted secret;
verifying at least one of authenticity, integrity, and freshness of the attestation request with the device;
performing a safety test configured to determine whether a predetermined condition is present;
initiating a secure boot with the device if the predetermined condition is not present;
if the secure boot is successful, the device creates a primary message comprising the encrypted secret, and sends the message to the ROT;
if the secure boot fails, the device creates a secondary message indicating that the secure boot has failed, and sends the message to the ROT.

2. The method of claim 1, wherein the legacy technology is related to a vehicle, and the predetermined condition is at least one of: the vehicle is in drive, the vehicle is not in park, or the vehicle is moving.

3. The method of claim 1, wherein the primary message further comprises an indication that the secure boot was successful.

4. The method of claim 1, wherein, if the secure boot fails, the device creates a message indicating that the secure boot has failed, and sends the message to the ROT.

5. The method of claim 1, wherein the integrity request is sent from a remote server to the ROT or based on a scheduled task stored by the ROT.

6. The method of claim 5, further comprising sending a message, with the ROT, to the remote server indicating whether the secure boot was successful or failed.

7. The method of claim 1, further comprising:
verifying the integrity of the received integrity request with the ROT; and
verifying the test is safe to proceed based on the verified integrity request.

8. A computer program product comprising a non-transitory computer useable medium including a computer readable code, wherein the computer readable code when executed using one or more computing device processors, causes the one or more computing processors to:
initiate an integrity request to a Root of Trust (ROT);
send an attestation request from the ROT to a device, the attestation request comprising an encrypted secret;
verify the of authenticity, integrity, and freshness of the attestation request with the device;
perform a safety test configured to determine whether a predetermined condition is present;
initiate a secure boot with the device if the predetermined condition is not present;
if the secure boot is successful, the device creates a primary message comprising the encrypted secret, and sends the message to the ROT;
if the secure boot fails, the device creates a secondary message indicating that the secure boot has failed, and sends the message to the ROT.

9. The computer program product of claim 8, wherein the computer readable code when executed using one or more computing device processors, causes the one or more computing processors to: perform a safety test and a reboot with the device.

10. The computer program product of claim 8, wherein the primary message further comprises an indication that the secure boot was successful.

11. The computer program product of claim 8, wherein, if the secure boot fails, the device creates a message indicating that the secure boot has failed, and sends the message to the ROT.

12. The computer program product of claim 8, wherein the integrity request is sent from a remote server to the ROT.

13. The computer program product of claim 12, wherein the computer readable code when executed using one or more computing device processors, causes the one or more computing processors to: send a message, with the ROT, to the remote server indicating whether the secure boot was successful or failed.

14. The computer program product of claim 8, wherein the computer readable code when executed using one or more computing device processors, causes the one or more computing processors to:
verify the integrity of the received integrity request with the ROT; and
verify the test is safe to proceed based on the verified integrity request.

15. A system comprising:
one or more computing system processors; and
memory storing instructions that, when executed by the one or more computing system processors, causes the system to:
send an integrity request to a Root of Trust (ROT);
send an attestation request from the ROT to a device, the attestation request comprising an encrypted secret;
verify at least one of authenticity, integrity, and freshness of the attestation request with the device;
perform a safety test configured to determine whether a predetermined condition is present;
initiate a secure boot with the device if the predetermined condition is not present;
if the secure boot is successful, the device creates a primary message comprising the encrypted secret, and sends the message to the ROT;
if the secure boot fails, the device creates a secondary message indicating that the secure boot has failed, and sends the message to the ROT.

16. The system of claim 15, wherein the ROT is associated with a vehicle, and the predetermined condition is at least one of: the vehicle is in drive, the vehicle is not in park, or the vehicle is moving.

17. The system of claim 15, wherein the primary message further comprises an indication that the secure boot was successful.

18. The system of claim 15, wherein, if the secure boot fails, the device creates a message indicating that the secure boot has failed, and sends the message to the ROT.

19. The system of claim 15, wherein the integrity request is sent from a remote server to the ROT, and the computer readable code when executed using one or more computing device processors, causes the one or more computing processors to: send a message, with the ROT, to the remote server indicating whether the secure boot was successful or failed.

20. The system of claim 15, wherein the computer readable code when executed using one or more computing device processors, causes the one or more computing processors to:
verify the integrity of the received integrity request with the ROT; and
verify the test is safe to proceed based on the verified integrity request.
